(19) United States
(12) Patent Application Publication
(10) Pub. No.: US 2025/0244572 A1
(43) Pub. Date: Jul. 31, 2025

(54) METHOD AND APPARATUS FOR REFERENCING AND VERIFYING THE FUNCTIONALITY OF AN OPTICAL METROLOGY DEVICE

(71) Applicant: OptoFidelity Oy, Tampere (FI)

(72) Inventors: Thomas KERST, Tampere (FI); Ville HAUTALA, Tampere (FI); Ari NEVALAINEN, Tampere (FI); Kimmo JOKINEN, Tampere (FI); Lasse LEPISTÖ, Tampere (FI); Jukka AHOLA, Tampere (FI)

(73) Assignee: OptoFidelity Oy, Tampere (FI)

(21) Appl. No.: 19/037,175

(22) Filed: Jan. 25, 2025

Related U.S. Application Data
(60) Provisional application No. 63/625,364, filed on Jan. 26, 2024.

(51) Int. Cl. G02B 27/00; G02B 27/01

(52) U.S. Cl. CPC G02B 27/0025; G02B 27/0101; G02B 2027/0116; G02B 2027/0123

(57) ABSTRACT

There are disclosed various methods and apparatuses for realizing optical referencing within an image transferring device. In some embodiments a projecting device is aligned with an input section of an image transferring device; a detecting device is aligned with an output section of the image transferring device; electromagnetic radiation is generated by the projecting device; the electromagnetic radiation is projected towards the input section of the image transferring device; the electromagnetic radiation transported by the image transferring device from the input section to the output section of the image transferring device is received; and the received electromagnetic radiation is analyzed.

### TECHNICAL FIELD

There is provided a method and an apparatus for realizing optical referencing within an image transferring device.

### BACKGROUND

Some optical elements have an input section for receiving electromagnetic signals and an output section for radiating electromagnetic signals propagated from the input section via the optical element to the output section. One example of such optical element is a waveguide, which can direct optical signals such as visible light, ultraviolet light, and/or infrared light.

Waveguides are used in various image transferring devices, such as augmented reality (AR) glasses and head-up displays (HUD). However, waveguide metrology, which is the measurement and characterization of waveguides, faces some challenges due to the placement of the measurement camera. Ideally, the camera should be opposite to the projection optics, but in practice, it is often next to them. This complicates the system referencing, which is the process of aligning the camera and the projection optics. Very common issue arising from this complicated system referencing is the image vignetting.

Vignetting is a phenomenon where the brightness and/or saturation of an image decreases towards the edges compared to the center. It can occur in optical systems due to various reasons. Mechanical vignetting occurs when some parts of the optical system, such as filters, lenses, or hoods, block or reduce the amount of light reaching the image sensor or film.

In an optical metrology measurement arrangement comprising a projecting device and a detecting device, in which the projecting device emits light towards an optical element such as a waveguide, and the detecting device receives light transported by the optical element, the detecting device may not be able to capture the full field of the projected, diverged light and instead only a small portion of it resulting vignetted image.

Optical vignetting occurs when the light rays from the edges of the lens aperture have a lower intensity than the ones from the center.

The conventional solution for system referencing is to rotate and reposition the camera mechanically, but this is costly, error-prone, and complex.

### SUMMARY

To address the drawbacks of the existing systems, there is provided an optical technique that aims to reveal and eliminate vignetting and/or some possible other undesired optical effects. This optical method may achieve at least the same level of referencing as the mechanical method. This technique has the potential to simplify waveguide metrology and provide a more efficient and reliable method for quality control metrology.

Some embodiments provide a method and an apparatus for providing a referencing for optical metrology measurement. Referencing in this context means that a combined performance of a projecting device and a detecting device is determined. This information may then be utilized in normal test cases to see the effect of the device under test (e.g. a waveguide) to the optical reference.

Various aspects of examples of the invention are provided in the detailed description.

The invention is based on the idea that the diverged light beam is scanned multiple times using different positions and poses. Therefore, the reconstruction of unvignetted image may be possible. The field of view can be recorded in full extent, or partially if it is desirable for cycle time needs. This can be achieved by making the measurement process more like the referencing process. This means that the measurement is carried out in transmission, i.e. that instead of replicating the actual use case of having projection optics next to the camera, one would place the camera into the referencing position and define it to be the correct location for an actual measurement.

The apparatus is a kind of an optical quality assessment arrangement, which can be used to measure not only the optical system vignetting but also other optical metrology metrics, such as uniformity.

According to a first aspect, there is provided a method for carrying out data collection, by scanning a diverged light beam multiple times, so that an end result is an unvignetted image. The method utilizes at least a set of two mirrors, arranged in order to reflect the diverged light beam from at least one projector to at least one camera. The camera performs at least one scan in a vertical or horizontal direction. To reach the desired outcome, also the projector can perform the scanning. It is also possible to scan by both the camera and the projector, either simultaneously or independently from each other. The scan area depends on e.g. the distance between the projecting device and the detecting device, field-of-view of the projecting device and the pupil of the detecting device.

According to a second aspect, there is provided an apparatus for carrying out a testing a sample which is capable of transferring electromagnetic radiation. The apparatus comprises at least a detecting device, at least one projecting device, a sample holder and at least two reflecting elements. The apparatus is configured to perform at least one scan at a predefined direction. As an outcome, the apparatus produces at least one unvignetted image which can be used to carry out any number of optical metrology measurements, like for example the image quality measurement. The outcome can also be multiple separate measurement points from different parts of the field-of-view. The target is still the same: to get reference performance for comparison i.e. how a device under test (DUT) affects the performance of a target system. An example of image quality measurement is a uniformity measurement, which addresses the absolute or relative nonuniformity of the electromagnetic radiation transferred by the sample.

Some advantageous embodiments are defined in the dependent claims. The present invention may improve the quality of testing of electromagnetic radiation transferring devices.

An implementation example is as a part of a waveguide (or light transfer device) test system to provide optical reference. The waveguide defines an optimal location for the projecting device and the detecting device.

### BRIEF DESCRIPTION OF THE DRAWINGS

For a more complete understanding of example embodiments of the present invention, reference is now made to the following descriptions taken in connection with the accompanying drawings in which:

FIG. 1 shows an example system for realizing optical referencing within an image transferring device according to an embodiment;

FIG. 2 shows an example system for realizing optical referencing within an image transferring device according to another embodiment;

FIG. 3 shows a flow diagram of a method according to an embodiment; and

FIGS. 4a and 4b illustrate different measurement repetitions.

### DETAILED DESCRIPTION OF SOME EXAMPLE EMBODIMENTS

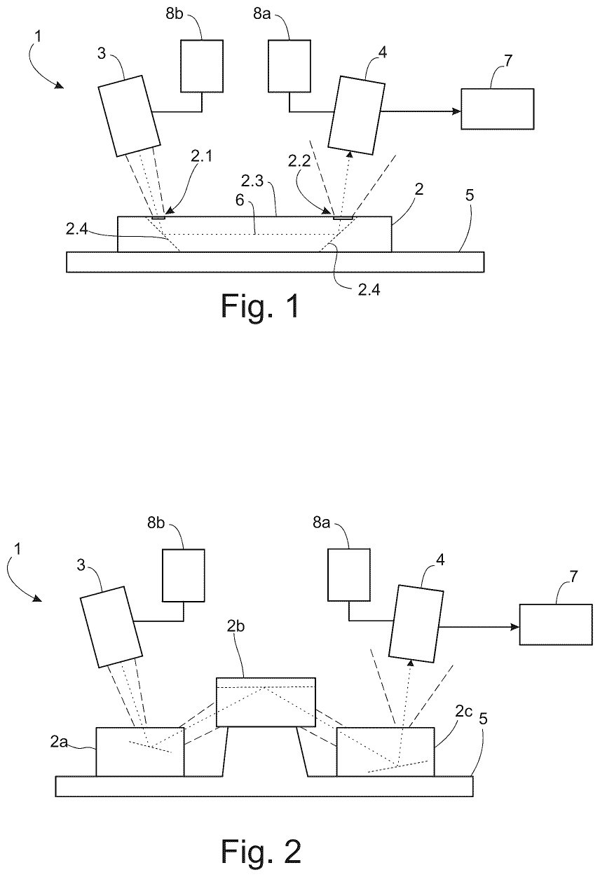

The example system 1 of FIG. 1 for realizing optical referencing within an image transferring device 2 comprises a projecting device 3 and a detecting device 4. The projecting device 3 may be movable or fixed. Movable means that the location and/or the pose of the projecting device 3 may be changed. Similarly, the detecting device 4 may be movable or fixed. If the detecting device 4 is movable, the location and/or the pose of the detecting device 4 may be changed.

The projecting device 3 can be regarded as a module of the present invention that delivers electromagnetic radiation to the image transporting device 2. For example, the projecting device 3 is a projector configured to project light.

The detecting device 4 can also be regarded as a module of the present invention that receives electromagnetic radiation from the image transporting device 2. For example, the detecting device 4 is a camera or comprises an image sensor capable of converting electromagnetic radiation to image signal, which, for example, may be displayed by a display (not shown). In addition to or instead of displaying the image signal, it may be analyzed by an image analyzer 7.

In accordance with an embodiment, the detecting device 4 has one or more lenses used to convert captured light from angular space to camera image plane. A lens entrance pupil affects the vignetted area size which may also be measured by the system.

The image analyzer 7 may measure optical system properties e.g. how the lens entrance pupil affects a vignetted area size, and possibly also other optical metrology metrics, such as uniformity.

The system 1 may also comprise a support 5 for the image transferring device 2 so that the image transferring device 2 can rest on the support 5 during measurements.

In an embodiment, the projecting device 3 is fixed to a certain location and pose and the detecting device 4 is movable, wherein the system 1 also comprises a first actuator 8a for moving the detecting device 4 and/or changing a pose of the detecting device 4.

In another embodiment, the detecting device 4 is fixed to a certain location and pose and the projecting device 3 is movable, wherein the system 1 also comprises a second actuator 8b for moving the projecting device 3 and/or changing a pose of the projecting device 3.

In various other embodiments both the projecting device 3 and the detecting device 4 are movable. Hence, the system 1 also comprises the first actuator 8a for moving the detecting device 4 and/or changing the pose of the detecting device 4 and second actuator 8b for moving the projecting device 3 and/or changing a pose of the projecting device 3, or the same actuator 8a, 8b may be used for moving the detecting device 4 and/or changing the pose of the detecting device 4 and for moving the projecting device 3 and/or changing a pose of the projecting device 3.

The image transferring device 2 may also be called as an image transporting device 2 or an electromagnetic radiation transferring device 2 due to the property that the image transferring device 2 is capable of transfer electromagnetic radiation such as images from an input section 2.1 to an output section 2.2 via an electromagnetic radiation transferring material 2.3. In other words, electromagnetic radiation may propagate from the input section 2.1 to the output section 2.2 through the electromagnetic radiation transferring material 2.3.

If the detecting device 4 is not moveable in space, then the projecting device 3 is moveable in space, or if the detecting device 4 is not moveable in space, then the projecting device 3 is moveable in space. However, as was already mentioned above, it is possible that both the projecting device 3 and the detecting device 4 are moveable in space at the same time.

According to the system of FIG. 1, the projecting device 3 is located on the same side of the image transporting device 2 as the detecting device 4.

It should be noted that a mechanical construction of the system 1 and elements 3-5 of the system 1 are not shown but only the principle of how these elements relate to each other regarding the propagation of the electromagnetic signal. Also, the details of the image transporting device 2 are not shown but only the operating principle of how electromagnetic radiation enters the image transporting device 2, propagates in the image transporting device 2, and exits the image transporting device 2. Therefore, the exact form and size of the image transporting device 2 may be different from the examples of FIGS. 1 and 2. It is also possible that different kinds (material, size, transparency etc.) of image transporting devices 2 may be tested by the system 1.

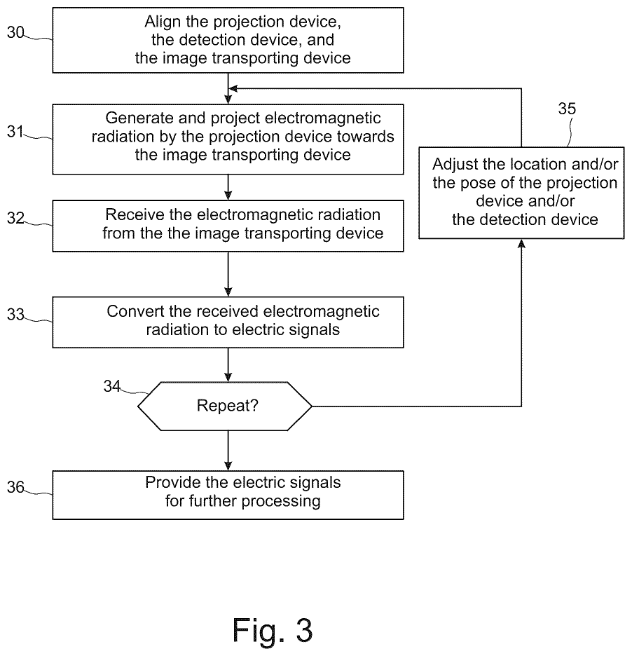

In the following the operation of the system 1 of FIG. 1 is described in more detail with reference to the flow diagram of FIG. 3.

The image transporting device 2 is placed on the support 5 and the elements of the system 1 are aligned 30 (FIG. 3) with respect to each other e.g. as follows. If the projecting device 3 is not movable, the image transporting device 2 is located on the support 5 so that the input section 2.1 of the image transporting device 2 is able to receive electromagnetic radiation from the projecting device 3. The detecting device 4 is moved, if not already at a proper location, so that the detecting device 4 is able to receive electromagnetic radiation from the output section 2.2 of the image transporting device 2.

On the other hand, if the detecting device 4 is not movable, the image transporting device 2 is located on the support 5 so that the output section 2.2 of the image transporting device 2 is able to output electromagnetic radiation to the detecting device 3. The projecting device 3 is moved, if not already at a proper location, so that the input section 2.1 of the image transporting device 2 is able to receive electromagnetic radiation from the projecting device 3.

If both the projecting device 3 and the detecting device 4 are movable, then they can be moved to proper locations so that the image transporting device 2 is able to receive electromagnetic radiation from the projecting device 3 and the detecting device 4 is able to receive electromagnetic radiation from the output section 2.2 of the image transporting device 2.

The projecting device 3 generates and projects 31 electromagnet radiation, such as visible light, infrared light and/or ultraviolet light, towards the input section 2.1 of the image transporting device 2. The image transporting device 2 receives by the input section 2.1 electromagnetic radiation from the projecting device 3 and transports the electromagnetic radiation through the electromagnetic radiation transferring material 2.3 to the output section 2.2. The dotted line 6 illustrates possible propagation of the electromagnetic radiation in the image transporting device 2.

The electromagnetic radiation is further radiated from the output section 2.2 and received 32 by the detecting device 4.

Then, an image sensor of the detecting device 4 converts 33 the electromagnetic radiation into electric signals. The procedure may be repeated 34 a number of times, wherein the location and/or the pose of at least one of the projecting device and the detecting device 4 may be adjusted 35. The electric signals from the image sensor of the detecting device 4 may be provided to the image analyzer 7 for further processing 34. Although FIG. 3 shows that the electric signals are forwarded to the image analyzer 7 after all the repetitions have been performed, it may also be possible to forward the electric signals after each repetition, wherein the electric signals from previous repetitions need not be stored by the detecting device 4.

The image analyzer 7 may perform the analysis after each repetition or it may use a plurality of electric signals from the repetitions to perform the analysis.

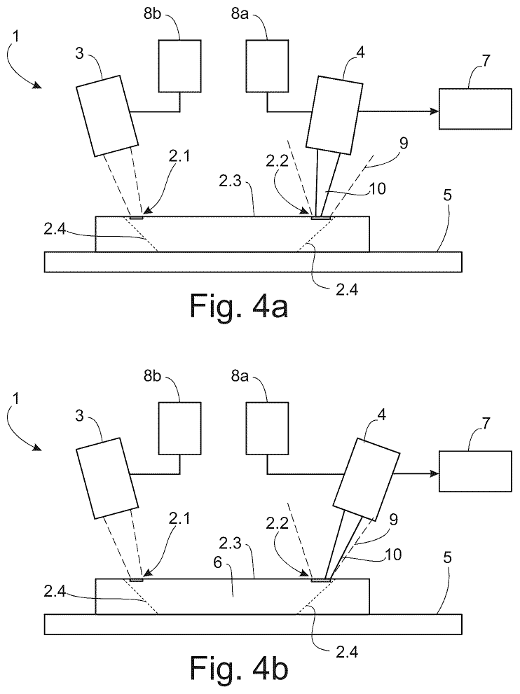

FIGS. 4a and 4b illustrate principle of two measurements performed at different locations and poses of the detecting device 4. The dotted cone 9 illustrates the whole visible area (field-of-view) and the other cone 10 illustrates a partial visible area i.e. the area seen by the optics (sensor) of the detecting device 4.

The image transporting device 2 contains two or more not necessarily identical radiation redirecting elements 2.4. The image transporting device 2 is further characterized by it being located such that the projecting device 3 and the detecting device 4 are located on the same side of the image transporting device 2. In other words, the input section 2.1 and the output section 2.2 are located at the same side with respect to the projecting device 3 and the detecting device 4.

A radiation redirecting element 2.4 receives electromagnetic radiation and then emits the received electromagnetic radiation again. Emitting electromagnetic radiation may mean that the radiation redirecting element 2.4 reflects or otherwise changes the direction of the electromagnetic radiation. Hence, emitting does not necessarily include active transmission of electromagnetic radiation.

The radiation redirecting element may alter the direction of the received radiation, its physical extent, change its intensity or its distribution. Two or more not necessarily identical radiation redirecting elements are used to form the image transporting device 2.

FIG. 2 shows an example system 1 according to another embodiment. In this example there are three image transferring devices 2a, 2b, 2c. A first image transferring device 2a receives the electromagnetic radiation from the projecting device 3 and outputs the electromagnetic radiation propagated via the first image transferring device 2a to a second image transferring device 2b. The second image transferring device 2b receives the electromagnetic radiation from the first image transferring device 2a and outputs the electromagnetic radiation propagated via the second image transferring device 2b to a third image transferring device 2c. The third image transferring device 2c receives the electromagnetic radiation from the second image transferring device 2b and outputs the electromagnetic radiation propagated via the third image transferring device 2c to the detecting device 4.

The method may be implemented for carrying out data collection, by scanning a diverged light beam multiple times, so that an end result is an unvignetted image or measurement points from different field locations. The method utilizes at least a set of two reflecting elements 2.3, such as mirrors, arranged in order to reflect the diverged light beam from at least one projector 3 to at least one camera 4. The camera 4 performs at least one scan in a vertical or horizontal direction. To reach the desired outcome, also the projector 3 can perform the scanning. It is also possible to scan by both the camera 4 and the projector 3, either simultaneously or independently from each other.

The image projection and detection procedure may be repeated multiple times so that at each repetition a different part of the field of view (FOW) of the input section 2.1 or the output section 2.2 of the image transporting device 2 is scanned. The field of view can be recorded in full extent, or partially if it is desirable for cycle time needs.

By combining the projecting device 3, the detecting device 4, the image transporting device 2 and either moving the projecting device 3, or the detecting device 4, or the projecting device 3 and the detecting device 4 together, one establishes a defined relation between the projecting device 3 and the detecting device 4. This way this defined relation between the projecting device 3 and the detecting device 4 can be established with the help of the image transporting device 2.

In accordance with an embodiment, a part of the field of view (FOV) or full field of view is reconstructed as an unvignetted image, or to get faster referencing speed, just few sample points are captured. For example, 12 points are captured from different parts of the FOV and those are used to adjust brightness of a previously captured reference image. Another use case could be to check few edge locations to get modulation transfer function (MTF) values (i.e. an ability of the optics to transfer the contrast of a sample to an image using spatial frequency) from different locations.

In accordance with an embodiment, the scanning may be performed in a plane, wherein the distance from the detecting device 4 to the projecting device 3 is not constant. This may make data capturing easier compared to situation where double curved scanning surface would be used.

In the following some examples will be provided.

According to a first example, there is provided a method comprising:
aligning a projecting device with an input section of an image transferring device;
aligning a detecting device with an output section of the image transferring device;
generating electromagnetic radiation by the projecting device;
projecting the electromagnetic radiation towards the input section of the image transferring device;
receiving electromagnetic radiation transported by the image transferring device from the input section to the output section of the image transferring device; and
analyzing the received electromagnetic radiation.

According to a second example there is provided a system comprising:
a projecting device for generating electromagnetic radiation and projecting the electromagnetic radiation towards an input section of an image transferring device;
a detecting device for receiving electromagnetic radiation transported by the image transferring device from the input section to an output section of the image transferring device;
an actuator for aligning at least one of the following:
   the projecting device with the input section of the image transferring device;
   the detecting device with the output section of the image transferring device. an analyzer for analyzing the received electromagnetic radiation.

1. A method comprising:
aligning a projecting device with an input section of an image transferring device;
aligning a detecting device with an output section of the image transferring device;
generating electromagnetic radiation by the projecting device;
projecting the electromagnetic radiation towards the input section of the image transferring device;
receiving electromagnetic radiation transported by the image transferring device from the input section to the output section of the image transferring device; and
analyzing the received electromagnetic radiation.

2. The method according to claim 1 comprising:
adjusting at least one of a location and a pose of the detecting device; and
receiving electromagnetic radiation at the adjusted location or pose.

3. The method according to claim 1 comprising:
adjusting at least one of a location and a pose of the projecting device; and
projecting electromagnetic radiation at the adjusted location or pose.

4. The method according to claim 1 comprising:
adjusting at least one of a location and a pose of the projecting device;
adjusting at least one of a location and a pose of the detecting device;
projecting electromagnetic radiation at the adjusted location or pose; and
receiving electromagnetic radiation at the adjusted location or pose.

5. The method according to claim 1 comprising:
receiving electromagnetic radiation transported by the image transferring device from a portion of the output section of the image transferring device;
adjusting at least one of a location and a pose of the detecting device; and
repeating the reception and adjustment several times to scan a predetermined area of the output section.

6. The method according to claim 1 comprising:
establishing a defined relation between the projecting device and the detecting device by utilizing the electromagnetic radiation transported via the image transporting device.

7. A system comprising:
a projecting device for generating electromagnetic radiation and projecting the electromagnetic radiation towards an input section of an image transferring device;
a detecting device for receiving electromagnetic radiation transported by the image transferring device from the input section to an output section of the image transferring device;
an actuator for aligning at least one of the following:
the projecting device with the input section of the image transferring device;
the detecting device with the output section of the image transferring device.
an analyzer for analyzing the received electromagnetic radiation.

8. The system according to claim 7, said analyzer configured to reconstruct a part of a field of view or a full field of view of the detecting device as an unvignetted image.

9. The system according to claim 7, said image transferring device comprising at least two electromagnetic radiation reflecting elements.
